(19) United States
(12) Patent Application Publication
(10) Pub. No.: US 2015/0125205 A1
(43) Pub. Date: May 7, 2015

(54) ASPHALT COMPOSITION

(71) Applicant: SHELL INTERNATIONALE RESEARCH MAATSCHAPPIJ B.V., The Hague (NL)

(72) Inventors: David Strickland, Greater Manchester (GB); Majid Jamshed Chughtai, Cheshire (GB); Sunil Ashtekar, Bangalore (IN)

(21) Appl. No.: 14/362,961

(22) PCT Filed: Dec. 7, 2012
(86) PCT No.: PCT/EP2012/074834

§ 371 Date: Jun. 5, 2014

(30) Foreign Application Priority Data
Dec. 8, 2011 (IN) 4281/CHE/2011

(51) Int. Cl. C08K 5/17; E01C 7/00; E01C 19/22; E01C 19/08; E01C 19/16; C08K 3/06; E01C 23/14

(52) U.S. Cl. CPC C08K 5/17; C08K 3/06; E01C 7/00; E01C 23/14; E01C 19/08; E01C 19/16; E01C 19/22
USPC 404/77; 106/284.4; 106/503

(57) ABSTRACT

An asphalt composition comprising aggregate, bitumen, sulphur and surfactant, wherein the surfactant is selected from cationic surfactants, amphoteric surfactants and mixtures thereof. Methods of preparing asphalt compositions and asphalt pavements are also disclosed.

### FIELD OF THE INVENTION

The invention relates to an asphalt composition and a process for the manufacture of an asphalt composition.

### BACKGROUND OF THE INVENTION

In the road construction and road paving industry, it is a well-practised procedure to coat aggregate material such as sand, gravel, crushed stone or mixtures thereof with hot fluid bitumen, spread the coated material as a uniform layer on a road bed or previously built road while it is still hot, and compact the uniform layer by rolling with heavy rollers to form a smooth surfaced road.

The combination of bitumen with aggregate material, such as sand, gravel, crushed stone or mixtures thereof, is referred to as “asphalt”. Bitumen, also referred to as “asphalt binder”, is usually a liquid binder comprising asphaltenes, resins and solvents. Bitumen can for example comprise pyrogenous mixtures derived from petroleum residues such as residual oils, tar or pitch or mixtures thereof.

It is known in the art that sulphur can be mixed with bitumen for applications in the road construction and road paving industry. Sulphur-modified bitumen is formulated by replacing some of the bitumen in conventional binders by elemental sulphur.

A problem that may be encountered during the production and paving of sulphur-containing asphalt is eye and throat irritation. The present inventors have sought to reduce worker eye and throat irritation during the production and paving of sulphur-containing asphalt.

### SUMMARY OF THE INVENTION

The present inventors have found that eye and throat irritation can be caused by the presence of sulphur vapour. During the sulphur-asphalt mix preparation process and while paving the road the prevailing temperature may be high enough to lead to amounts of sulphur vapour that can cause eye and throat irritation to nearby workers. At the elevated temperatures the vapour pressure of sulphur is sufficiently high to result in the presence of high amounts of sulphur vapour. The sulphur vapour that is in equilibrium above the hot asphalt mix will undergo deposition when in contact with a suitable surface.

The present inventors have found that by incorporating a particular surfactant into the sulphur-containing asphalt it is possible to reduce the quantity of sulphur vapour and thereby decrease the amount of eye and throat irritation experienced by workers.

Accordingly, the present invention provides an asphalt composition comprising aggregate, bitumen, sulphur and surfactant selected from cationic surfactant, amphoteric surfactant and mixtures thereof. Preferably the amount of surfactant in the asphalt composition is from 0.05 wt % to 10 wt %, based upon the weight of the sulphur.

In another aspect, the present invention provides a process for manufacturing an asphalt composition according to the present invention, the process comprising the steps of:

(i) heating bitumen;
(ii) heating aggregate;
(iii) mixing the hot bitumen with the hot aggregate in a mixing unit to form an asphalt composition;
wherein sulphur is added in at least one of steps (i), (ii) or (iii); and wherein preferably from 0.05 wt % to 10 wt % of surfactant, based upon the weight of the sulphur, is added in at least one of the steps (i), (ii) or (iii), wherein said surfactant is selected from cationic surfactants, amphoteric surfactants, and mixtures thereof.

The invention further provides a process for preparing an asphalt pavement, wherein asphalt is prepared by a process according to the invention, and further comprising steps of:

(iv) spreading the asphalt into a layer; and
(v) compacting the layer.

In an embodiment of the invention, the sulphur and the cationic and/or amphoteric surfactant are added together; the sulphur is in the form of pellets and the surfactant is incorporated in the sulphur pellets. Accordingly the invention further provides sulphur pellets comprising surfactant in an amount from 0.05 wt % to 10 wt %, based upon the weight of the sulphur, wherein the surfactant is selected from cationic surfactants, amphoteric surfactants and mixtures thereof. These pellets are advantageously used in a process according to the invention.

In an alternative embodiment of the invention, instead of incorporating the cationic and/or amphoteric surfactant into the asphalt composition, the cationic and/or amphoteric surfactant can be sprayed into the atmosphere as the asphalt pavement is laid. Accordingly, the present invention provides a process for preparing an asphalt pavement, the process comprising the steps of:

(i) heating bitumen;
(ii) heating aggregate;
(iii) mixing the hot bitumen with the hot aggregate in a mixing unit to form an asphalt composition;
(iv) spreading the asphalt composition into a layer; and
(v) compacting the layer;
wherein sulphur is added in at least one of steps (i), (ii) or (iii); and wherein surfactant, preferably in an amount of from 0.05 wt % to 10 wt % based upon the weight of the sulphur, is sprayed above the layer in steps (iv) and/or (v), wherein the surfactant is selected from cationic surfactants, amphoteric surfactants and mixtures thereof. Such a process also reduces eye and throat irritation experienced by workers during preparation of an asphalt pavement.

### DETAILED DESCRIPTION OF THE INVENTION

The asphalt composition according to the invention comprises aggregate, bitumen, sulphur and surfactant selected from cationic surfactants, amphoteric surfactants and mixtures thereof.

The aggregate is suitably any aggregate that is suitable for road applications. The aggregate may comprise coarse aggregate (retained on a 4 mm sieve), fine aggregate (passes a 4 mm sieve but is retained on a 63 μm sieve) and/or filler (passes a 63 μm sieve).

Typically, the asphalt composition comprises at least 1 wt % of bitumen, based on the weight of the asphalt composition. An asphalt composition comprising from about 1 wt % to about 10 wt % of bitumen is preferred, with a special preference for asphalt compositions comprising from about 3 wt % to about 7 wt % of bitumen, based on the weight of the asphalt composition.

The bitumen can be selected from a wide range of bituminous compounds. The bitumen that can be employed may be straight run bitumen, thermally cracked residue or precipitation bitumen, e.g. from propane. Although not necessary, the bitumen may also have been subjected to blowing. The blowing may be carried out by treating the bitumen with an oxygen-containing gas, such as air, oxygen-enriched air, pure oxygen or any other gas that comprises molecular oxygen and an inert gas, such as carbon dioxide or nitrogen. The blowing operation may be conducted at temperatures of 175 to 400° C., preferably from 200 to 350° C. Alternatively, the blowing treatment may be conducted by means of a catalytic process.

The bitumen for use herein is preferably a paving grade bitumen suitable for road application having a penetration of, for example, from 9 to 1000 dmm, more preferably of from 15 to 450 dmm (tested at 25° C. according to EN 1426: 1999) and a softening point of from 25 to 100° C., more preferably of from 25 to 60° C. (tested according to EN 1427: 1999).

The amount of sulphur in the asphalt composition is preferably from 10 to 200 wt %, based upon the weight of the bitumen, preferably from 20 wt %, more preferably from 30 wt % and preferably to 100 wt %, more preferably to 80 wt %. The presence of sulphur in the asphalt paving mixture can improve the strength and rutting resistance of the paving mixture and it is important to include sufficient sulphur to realise these advantages. Additionally, incorporating increased amounts of sulphur can decrease the cost of the paving mixture. However, too much sulphur can decrease the workability of the paving mixture.

The sulphur may be incorporated into the asphalt composition in the form of sulphur pellets. Reference herein to pellets is to any type of sulphur material that has been cast from the molten state into some kind of regularly sized particle, for example flakes, slates or sphere-shaped sulphur such as prills, granules, nuggets and pastilles or half pea sized sulphur. The sulphur pellets typically comprise from 50 to 100 wt % of sulphur, based upon the weight of the sulphur pellets, preferably from 60 wt % and most preferably from 70wt %; and typically to 99 wt %, and preferably to 95 wt % or to 100 wt %. A more preferred range is from 60 to 100 wt %.

These sulphur pellets may contain carbon black and, optionally, other ingredients, such as amyl acetate and wax. Carbon black may be present in amounts up to 5% wt, based on the pellet, preferably up to 2% wt. Suitably, the content of carbon black in the sulphur pellet is at least 0.25% wt. The content of other ingredients, such as amyl acetate and wax, typically does not exceed an amount of 1.0% wt each. When wax is present, it may be in the form of, for example, slack wax or wax derived from a Fischer-Tropsch process. Examples of suitable waxes for use herein are Sasobit®, a Fischer-Tropsch derived wax commercially available from Sasol, and SX100 wax, a Fischer-Tropsch wax from Shell Malaysia.

An example of a suitable sulphur pellet for use herein is Thiopave® pellets commercially available from Shell Canada.

Preferably, the surfactant used in the present invention is selected from a cationic surfactant, an amphoteric surfactant, and mixtures thereof. As used herein, the terms ‘cationic surfactant’ and ‘amphoteric surfactant’ refer to compounds present in their cationic or amphoteric form as well as those that will be converted into their cationic or amphoteric form (e.g. by protonation or alkylation) in situ.

Suitable cationic surfactants include, but are not limited to, nitrogen-containing cationic surfactants. Nitrogen-containing cationic surfactants will generally be selected from the group of aliphatic nitriles (RCN), aliphatic amides (RCONH₂), aliphatic amines (e.g. RNH₂, RRNH, R(CH₃)₂N, R(CH₃)₃N⁺, RR(CH₃)N), R₃N), aliphatic polyamines ((RNHR′), NH₂), beta primary aliphatic amines (e.g. RCH(NH₂)CH₃), beta aliphatic polyamines, aryl aliphatic amines (e.g. R(C₆H₅)NH₂ include the benzyl derivatives e.g. RN(CH₃)₂CH₂C₆H₅), etheramines (e.g. ROR′NH₂) or non-aromatic cyclic amines (e.g. alkylimidazolines and alkyl morpholines), or derivatives of any of the compounds listed above, such as their salts, ethylene or propylene oxide adducts or quaternary ammonium salts.

Especially preferred cationic surfactants are fatty amine alkoxylates represented by the general formula R¹NR²R³, wherein R¹ is an aliphatic moiety containing from 12 to 20 carbon atoms and R² and R³ are each independently aliphatic moieties containing from 2 to 25 ethoxy/propoxy units. Preferably R² and R³ are identical.

Suitable amphoteric surfactants include, but are not limited to, nitrogen-containing amphoteric surfactants. These may be selected from the group consisting of amine oxides (RNH₂O, RNH(CH₃)O, RN(CH₃)₂O), betaine derivatives (e.g. RNH(CH₂CO₂) RN(CH₃)(CH₂CO₂) or RN(CH₃)₂(CH₂CO₂)) alkylamido-propylbetaines (e.g. RCONHR′N(CH₃)₂(CH₂CO₂)), sultaines (e.g. RN(CH₃)₂R′SO₃ or RCONHR′N(CH₃)₂ CH₂CH(OH)CH₂SO₃)), Lecithins (e.g. (CH₃)₃NR′OP(O)₂OCH₂CH(OCO₂R)CH₂OCO₂R or partially hydrolysed derivatives thereof) or derivatives of any of the compounds listed above, such as their salts, ethylene or propylene oxide adducts or quaternary ammonium salts.

As used herein, R represents substituted or unsubstituted aliphatic radicals of from 8 to 22, preferably 12 to 20, more preferably 16 to 20, carbon atoms, R′ represents an alkyl radical of from 2 to 4 carbon atoms and n represents an integer of from 1 to 3.

Preferably, the at least one surfactant is selected from aliphatic amines (e.g. RNH₂, RRNH, R(CH₃)₂N, R(CH₃)₃N⁺, RR(CH₃)N, R₃N) and their ethylene or propylene oxide adducts. In a particularly preferred embodiment of the present invention, the at least one surfactant is an ethylene or propylene oxide adduct of an aliphatic amine, wherein R is an aliphatic radical containing in the range of from 12 to 20 carbon atoms, more preferably from 16 to 20 carbon atoms. In this embodiment the ethylene or propylene oxide adduct of an aliphatic amine is more preferably the ethylene or propylene oxide adduct of a tallow amine.

A particularly preferred surfactant for use herein is that commercially available under the tradename Toximul TA5 (a cationic surfactant based on tallow amine ethoxylate), available from Stepan Company (Northfield, Ill., USA).

Suitably, the total amount of cationic and/or amphoteric surfactant is in the range of from 0.05 wt % to 10 wt %, based upon the weight of the sulphur. Preferably the total amount of cationic and/or amphoteric surfactant is in the range of from 0.1 to 8 wt %, more preferably in the range of from 0.2 to 6 wt %, and most preferably in the range of from 1 to 5 wt %, with respect to the weight of the sulphur. Sufficient cationic and/or amphoteric surfactant should be incorporated to achieve the desired reduction in sulphur vapour and eye and throat irritation, but larger quantities will incur greater expense.

The asphalt composition of the invention may suitably comprise additional components. In one embodiment of the invention the asphalt composition comprises an anionic surfactant in an amount of from 0.05% to 10%, based on the weight of sulphur. The anionic surfactant is suitably chosen from the group consisting of lignin derivatives such as lignosulphonates; aromatic sulphonates and aliphatic sulphonates and their formaldehyde condensates and derivatives; fatty acids and carboxylates, including sulphonated fatty acids; and phosphate esters of alkylphenol-, polyalkylaryl- or alkyl-alkoxylates.

The asphalt composition of the invention may suitably comprise further additional components. In one embodiment of the invention, the asphalt composition comprises a polymer. A preferred type of polymer is a copolymer comprising one or more vinyl aromatic compounds and one or more conjugated dienes, in an amount of 0.1 to 7% wt, based upon the weight of the asphalt composition. More preferably the polymer is a linear styrene-butadiene-styrene block copolymer of formula ABA wherein A is a polystyrene block and B is a polybutadiene block. Another preferred type of polymer is a copolymer formed from monomers including ethylene and glycidyl methacrylate or glycidyl acrylate, in an amount of 0.1 to 7% wt, based upon the weight of the asphalt composition. More preferably the polymer is a terpolymer formed from ethylene, alkyl acrylate and glycidyl methacrylate or glycidyl acrylate.

In step (i) of the processes for manufacturing the present asphalt compositions the bitumen is heated, preferably at a temperature of from 60° C. to 200° C., preferably from 80 to 150° C., more preferably from 100° C. to 145° C., and even more preferably from 125° C. to 145° C. Working above 120° C. has the advantage that sulphur is liquid which facilitates the mixing process. Although the skilled person can easily determine the optimal mixing time the mixing time may be relatively short, e.g., from 10 to 600 seconds.

In step (ii) of the process for manufacturing the present asphalt composition the aggregate is heated, preferably at a temperature of from 60 to 200° C., preferably from 80 to 170° C., more preferably from 100 to 160° C., even more preferably from 100 to 145° C.

In step (iii) of the asphalt manufacturing process, the hot bitumen from step (i) and hot aggregate from step (ii) are mixed in a mixing unit. Suitably, the mixing takes place at a temperature of from 80 to 200° C., preferably from 90 to 150° C., more preferably from 100 to 145° C. Typically, the mixing time is from 10 to 60 seconds, preferably from 20 to 40 seconds.

Sulphur is preferably added as late as possible in the process, preferably in step (iii). Sulphur is preferably added in the form of pellets.

The sulphur and the cationic and/or amphoteric surfactant may be added together, i.e. both in step (i), step (ii) or step (iii). In a first embodiment, the hot aggregate is mixed with the sulphur and the cationic and/or amphoteric surfactant. Hot bitumen is then added to the hot aggregate-sulphur-cationic and/or amphoteric surfactant mixture. In a second embodiment, hot aggregate is mixed with hot bitumen, and the sulphur and the cationic and/or amphoteric surfactant are added to the hot bitumen-aggregate mixture. This embodiment offers the advantage of producing a stronger sulphur-asphalt mixture strength. In a third embodiment, hot bitumen is mixed with sulphur and the cationic and/or amphoteric surfactant and the resulting hot bitumen-sulphur-cationic and/or amphoteric surfactant mixture is mixed with hot aggregate to obtain a sulphur-comprising asphalt mixture.

Alternatively, in the asphalt manufacture process the cationic and/or amphoteric surfactant may be added separately. For example, the cationic and/or amphoteric surfactant may be added to the bitumen in step (i) and the sulphur may be added in step (iii).

In one embodiment of the invention, the sulphur and the cationic and/or amphoteric surfactant are added together; the sulphur is in the form of pellets and the cationic and/or amphoteric surfactant is incorporated in the sulphur pellets. The sulphur pellets preferably comprise from 0.05 to 10 wt % of the cationic and/or amphoteric surfactant, based upon the weight of the sulphur. The sulphur pellets are suitably prepared by a process wherein liquid sulphur is mixed with the cationic and/or amphoteric surfactant and optionally additional components such as, anionic surfactant, carbon black and amyl acetate. The mixture is then shaped and/or pelletised.

In one embodiment of the invention sulphur may be added in the form of two types of sulphur pellets; a first type of sulphur pellet that comprises the cationic and/or amphoteric surfactant and a second type of sulphur pellet that does not comprise the cationic and/or amphoteric surfactant. This has the advantage that the cationic and/or amphoteric surfactant is essentially concentrated in the first type of sulphur pellet and conventional sulphur pellets can be used to make up the rest of the sulphur requirement.

The invention further provides a process for preparing an asphalt pavement, wherein asphalt is prepared by a process according to the invention, and further comprising steps of:

(iv) spreading the asphalt into a layer; and
(v) compacting the layer.

The invention further provides an asphalt pavement prepared by the process according to the invention.

The compaction in step (v) suitably takes place at a temperature of from 80 to 200° C., preferably from 90 to 150° C., more preferably from 95 to 130° C. The temperature of compaction is desirably kept as low as possible in order to reduce hydrogen sulphide emissions. However, the temperature of compaction needs to be sufficiently high such that the voids content of the resulting asphalt is sufficiently low for the asphalt to be durable and water resistant.

In an alternative embodiment, the present invention provides a process for preparing an asphalt pavement, the process comprising the steps of:

(i) heating bitumen;
(ii) heating aggregate;
(iii) mixing the hot bitumen with the hot aggregate in a mixing unit to form an asphalt composition;
(iv) spreading the asphalt composition into a layer; and
(v) compacting the layer;
wherein sulphur is added in at least one of steps (i), (ii) or (iii); and wherein surfactant, preferably in an amount of from 0.05 wt % to 10 wt %, based upon the weight of the sulphur, is sprayed above the layer in steps (iv) and/or (v), wherein the surfactant is selected from cationic surfactants, amphoteric surfactants and mixtures thereof. The preferred formulations and conditions for the process, including the preferred cationic and/or amphoteric surfactant, are substantially as described above. Spraying the cationic and/or amphoteric surfactant into the atmosphere above the layer can be accomplished by any suitable means. The cationic and/or amphoteric surfactant is preferably used as an aqueous solution, or may alternatively be used as a solution in an organic solvent.

The invention will now be illustrated by means of the following Examples, which are not intended to limit the scope of the invention.

### EXAMPLES

A blend of elemental sulphur and bitumen was heated to 145-148° C. The bitumen was a 60/70 penetration grade bitumen and the weight ratio of sulphur: bitumen was 30:70. Toximul TA-5 (a cationic surfactant based on tallow amine ethoxylate, available from Stepan Company (Northfield, Ill., USA)) was added while the stirring was continued for 3 hours. Evaporated sulphur was collected on a filter paper for 3 hours and its weight was measured gravimetrically to determine the sulphur loss. This was compared with the control experiment with no additive to measure % sulphur loss.

It was observed that sulphur loss varied between control experiments; this may have been due to inhomogeneous stirring or bitumen aging effects. To ensure that an accurate comparison could be made between experimental examples and control examples, a control example was carried out alongside each experimental example.

Additive amounts are reported as weight percentages, based upon the weight of the sulphur.

Results are shown in Table 1:

TABLE 1

| | Wt % cationic | | |
|---|---|---|---|
| | surfactant | Sulphur | Sulphur |
| | (wt % based on | reduction % | reduction % |
| | weight of S) | Run 1 | Run 2 |
| Experiment 1 | 1.5 | 36 | 27 |

Even though the experiments do not relate to asphalt compositions of the invention (the experimental blends comprise bitumen, sulphur and cationic surfactant but no aggregate), the inventors believe that the results demonstrate a significant reduction in elemental sulphur vapour which would also be experienced when blending bitumen, sulphur, aggregate and cationic/amphoteic surfactant. The experiments showed a significant reduction in sulphur vapour.

1. An asphalt composition comprising aggregate, bitumen, sulphur and surfactant selected from cationic surfactants, amphoteric surfactants and mixtures thereof.

2. An asphalt composition according to claim 1 wherein the surfactant is a cationic surfactant.

3. An asphalt composition according to claim 1 wherein the surfactant is a nitrogen-containing cationic surfactant.

4. An asphalt composition according to claim 1, wherein the amount of surfactant is from 0.05 wt % to 10 wt %, based upon the weight of the sulphur.

5. An asphalt composition according to claim 1 wherein the surfactant comprises an ethylene or propylene oxide adduct of an aliphatic amine, said aliphatic amine containing 12 to 20 carbon atoms.

6. An asphalt composition according to claim 1, comprising from 1 wt % to 10 wt % of bitumen, based on the weight of the asphalt composition.

7. An asphalt composition according to claim 1, wherein the amount of sulphur is from 10 to 200 wt %, based upon the weight of the bitumen.

8. A process for manufacturing an asphalt composition according to claim 1, the process comprising the steps of:
(i) heating bitumen;
(ii) heating aggregate;
(iii) mixing the hot bitumen with the hot aggregate in a mixing unit to form an asphalt composition;
wherein sulphur is added in at least one of steps (i), (ii) or (iii); and wherein from 0.05 wt % to 10 wt % of surfactant, based upon the weight of the sulphur, is added in at least one of the steps (i), (ii) or (iii), wherein the surfactant is selected from cationic surfactants, amphoteric surfactants and mixtures thereof.

9. A process for manufacturing an asphalt composition according to claim 8, wherein sulphur is added in the form of pellets.

10. A process for manufacturing an asphalt composition according to claim 9, wherein the sulphur pellets and the surfactant are added together and the surfactant is incorporated in the sulphur pellets.

11. A process for preparing an asphalt pavement, wherein an asphalt composition is prepared by a process according to claim 8, and further comprising steps of:
(iv) spreading the asphalt into a layer; and
(v) compacting the layer.

12. Sulphur pellet comprising surfactant in an amount from 0.05 wt % to 10 wt %, based upon the weight of the sulphur, wherein the surfactant is selected from cationic surfactants, amphoteric surfactants and mixtures thereof.

13. A process for preparing an asphalt pavement, the process comprising the steps of:
(i) heating bitumen;
(ii) heating aggregate;
(iii) mixing the hot bitumen with the hot aggregate in a mixing unit to form an asphalt composition;
(iv) spreading the asphalt composition into a layer; and
(v) compacting the layer;
wherein sulphur is added in at least one of steps (i), (ii) or (iii); and wherein surfactant, preferably in an amount of from 0.05 wt % to 10 wt %, based upon the weight of the sulphur, is sprayed above the layer in steps (iv) and/or (v), wherein the surfactant is selected from cationic surfactants, amphoteric surfactants and mixtures thereof.
